(19) United States
(12) Patent Application Publication
(10) Pub. No.: US 2007/0172254 A1
(43) Pub. Date: Jul. 26, 2007

(54) DEVICE HOLDER WITH SUPPORTING MEMBER

(75) Inventor: JIUNN-HER LI, TU CHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,576

(22) Filed: Apr. 8, 2006

(30) Foreign Application Priority Data
Jun. 17, 2005 (CN) 200510035421.9

(51) Int. Cl. G03G 15/16

(52) U.S. Cl. 399/122

(57) ABSTRACT

A device holder includes a housing (10) and a supporting member (20), the supporting member includes a main portion (200) and at least one fixing member (212) disposed on the main portion (200). The fixing member further includes a control portion (2124), a latch (2126) extending up from the control portion (2124), and a resilient arm connecting the control portion and the latch to the main portion. The housing (10) comprises a wall (100) and one groove (110) formed in the wall for receiving the latch (2126) of the fixing member (212). The structure of the supporting member is simple, and it can be easily attached or removed from the housing.

### FIELD OF THE INVENTION

The present invention relates to a device holder, and specifically to a device holder with a supporting member.

### DESCRIPTION OF RELATED ART

Many devices, and particularly electronic devices such as access points, modems, ADSL's (Asymmetric Digital Subscriber Lines), and so on, are commonly used nowadays. Conventionally, these devices are configured to be placed on a surface in a horizontal position when in use. However, in many conditions, it may be inconvenient to place the device in a horizontal position because of limited space.

Therefore, a heretofore unaddressed need exists in the industry to overcome the aforementioned deficiencies and inadequacies.

### SUMMARY OF INVENTION

In one aspect of the embodiment, a device holder includes a supporting member and a housing. The housing includes a wall and at least one groove. The supporting member includes a main portion and at least one fixing member disposed on the main portion. The fixing member further includes a control portion, a latch extending up from the control portion, and a resilient arm connecting the control portion and the latch to the main portion. After assembly, the latch can be received in the groove of the housing and a distal end of the latch of the fixing member can hook an inner surface of the wall of the housing.

In another aspect of the embodiment, a supporting member of a device holder includes a main portion and at least one fixing member disposed on the main portion. The fixing member includes a control portion, a latch extending up from the control portion, and a resilient arm connecting the control portion and the latch to the main portion.

Other advantages and novel features will become more apparent from the following detailed description when taken in conjunction with the accompanying drawings, in which:

### BRIEF DESCRIPTION OF DRAWINGS

FIG. 1 is an exploded, isometric view of a device holder in accordance with an exemplary embodiment of the present invention;

FIG. 2 is an assembled view of FIG. 1;

FIG. 3 is an inverted view of FIG. 2; and

FIG. 4 is an isometric view of a device holder in accordance with another exemplary embodiment of the present invention.

### DETAILED DESCRIPTION

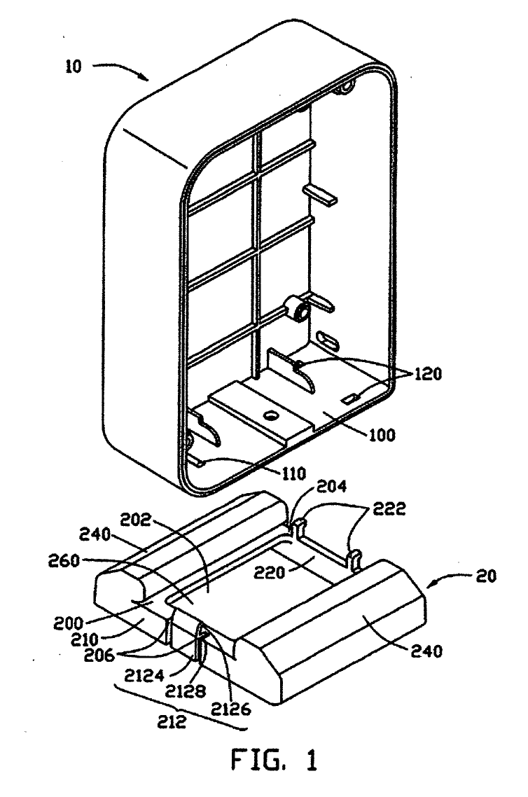

Referring to FIG. 1, a device holder in accordance with an exemplary embodiment of the present invention includes a housing 10 and a supporting member 20.

The housing 10 is used for receiving devices such as electrical components (not shown), however there is potential for the housing 10 to house some other components such as a clock, picture, etc. The housing 10 includes a wall 100. A groove 110 and a pair of holes 120 are defined in the wall 100, for mounting the supporting member 20 to the housing 10.

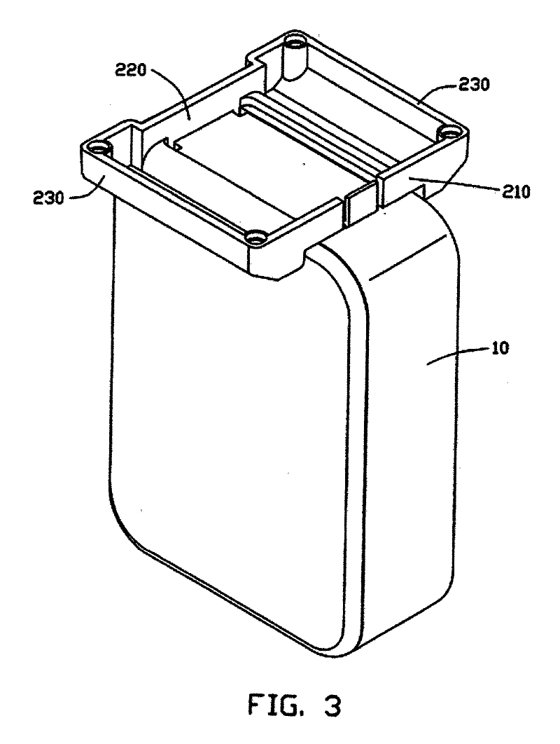

Referring also to FIG. 3, the supporting member 20 includes a main portion 200, a pair of protecting portions 240, a first sidewall 210, a second sidewall 220 opposite to the first sidewall 210, and a pair of opposite third sidewalls 230. The main portion 200 includes an upper surface 204 and an opening 202. The opening 202 is defined in the main portion 200. After assembly, information on the wall 100 of the housing 10 can be viewed through the opening 202. The protecting portions 240 extend up from two opposite sides of the upper surface 204 of the main portion 200, thereby an accommodating space 260 is formed between the protecting portions 240 and the main portion 200. After assembly, a part of the housing 10 is accommodated in the accommodating space 260. The first sidewall 210, the second sidewall 220, and the third sidewalls 230 respectively extend down from the main portion 200, and the third sidewalls 230 interconnect the first sidewall 210 and the second sidewall 220.

A pair of hooks 222 extends up from one side of the upper surface 204 of the main portion 200, adjacent to the protecting portions 240 respectively, and a pair of slots 206 is defined opposite the hooks 222 on the upper surface 204. The slots 206 penetrate from the first sidewall 210 into the main portion 200, thereby a fixing member 212 is formed between the slots 206. The fixing member 212 includes a control portion 2124, a latch 2126 extending up from the control portion 2124, and a resilient arm 2128. The resilient arm 2128 extends from a joint of the control portion 2124 and the latch 2126 into the main portion 200.

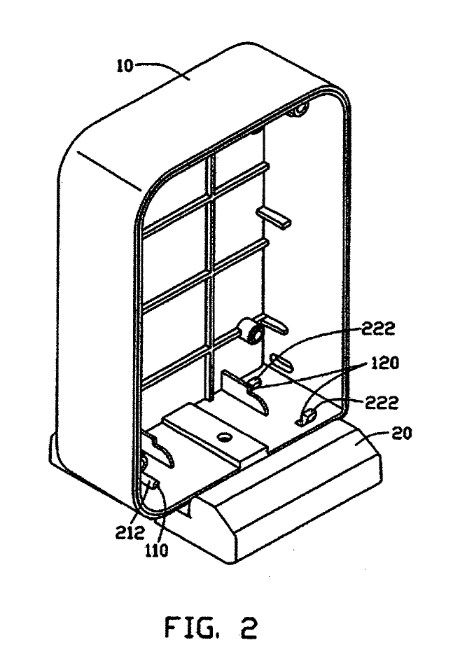

Referring to FIGS. 1-3, in assembly, the hooks 222 of the supporting member 20 are inserted into the corresponding holes 120 of the housing 10, and the latch 2126 of the fixing member 212 is received in the groove 110 of the housing 10. Thus, the housing 10 is mounted on the supporting member 20. In this position, a distal end of each hook 222 hooks an inner surface of the wall 100 of the housing 10, and a distal end of the latch 2126 of the fixing member 212 hooks an inner surface of the wall 100 of the housing 10.

In disassembly, when the control portion 2124 of the fixing member 212 is pushed by external force, the fixing member 212 is resiliently distorted, and the latch 2126 disengages from the wall 100. Thereby the latch 2126 and the hooks 222 disengage in turn from the inner surface of the wall 100 of the housing 10. Thus the supporting member 20 can be removed from the housing 10 easily.

In the embodiment, the groove 110 and the holes 120 of the housing 10 not only receive the latch 2126 and the hooks 222 of the supporting member 20 respectively, but also dissipate heat generated by the electronic components received in the housing 10.

The housing 10 is unlikely to be accidentally pulled out of the supporting member 20 during operation, since a part of the housing 10 is accommodated in the accommodating space 260, and the hooks 222 and the latch 2126 of the supporting member 20 are respectively received in the holes 120 and the groove 110 of the housing 10.

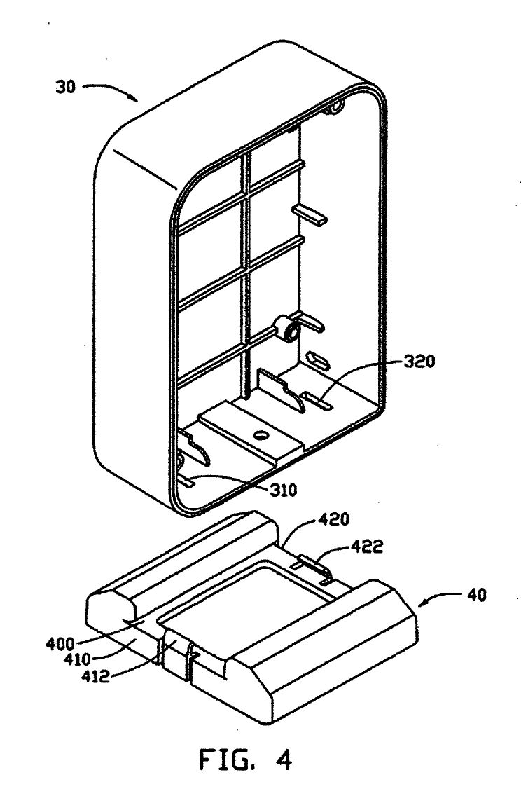

FIG. 4 shows a housing 30 and a supporting member 40 in accordance with another exemplary embodiment of the present invention. The housing 30 has a similar structure to that of the housing 10, and includes a pair of grooves 310, 320 defined in a wall thereof. The supporting member 40 has a similar structure to that of the supporting member 20, and includes a main portion 400, a first sidewall 410, a second sidewall 420 opposite to the first sidewall 410, and two fixing members 412, 422 are used instead of the hooks 222 of the supporting member in FIG. 1. The fixing member 422 is disposed on the second sidewall 420 and connected to the main portion 400. The fixing member 412 is disposed on the first sidewall 210 and connected to the main portion 400, and is opposite to the fixing member 422. The fixing member 422 and the fixing member 412 have same elements and perform same function. The fixing members 412, 422 are respectively received in the grooves 310, 320 of the housing 30 in assembly. The housing 30 and the supporting member 40 respectively have similar characteristics and functions as the housing 10 and the supporting member 20.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A device holder, comprising:
a supporting member comprising a main portion and at least one fixing member disposed on the main portion, the fixing member comprising a control portion, a latch extending up from the control portion, and a resilient arm connecting the control portion and the latch to the main portion,
a housing comprising a wall and at least one groove defined in the wall, the groove for receiving the latch of the fixing member.

2. The device holder of claim 1, wherein the supporting member comprises at least one hook extending up from the main portion.

3. The device holder of claim 1, wherein the supporting member comprises a first sidewall, a second sidewall opposite to the first sidewall, and a pair of third sidewalls interconnecting the first sidewall and the second sidewall.

4. The device holder of claim 3, wherein the first, second, and third sidewalls extend down from the main portion.

5. The device holder of claim 4, wherein a pair of slots is defined in the supporting member, each of the slots penetrates from the first sidewall into the main portion, and the fixing member is disposed between the two slots.

6. The device holder of claim 1, wherein the supporting member comprises a pair of protecting portions extending up from the main portion.

7. The device holder of claim 1, wherein the main portion comprises an opening defined in a center thereof.

8. A supporting member of a device holder, comprising:
a main portion; and
at least one fixing member disposed on the main portion, the fixing member comprising a control portion, a latch extending up from the control portion, and a resilient arm connecting the control portion and the latch to the main portion.

9. The supporting member of claim 8, further comprising at least one hook extending up from the main portion.

10. The supporting member of claim 8, further comprising a first sidewall, a second sidewall opposite to the first sidewall, and a pair of third sidewalls interconnecting the first sidewall and the second sidewall.

11. The supporting member of claim 10, wherein the first, second, and third sidewalls extend down from the main portion.

12. The supporting member of claim 11, further comprising a pair of slots, each of the slots penetrating from the first sidewall into the main portion, and the fixing member disposed between the slots.

13. The supporting member of claim 8, further comprising a pair of protecting portions extending up from the main portion.

14. The supporting member of claim 8, wherein the main portion comprises an opening defined in a center thereof.
